(19) United States
(12) Patent Application Publication
(10) Pub. No.: US 2024/0241988 A1
(43) Pub. Date: Jul. 18, 2024

(54) METHODS AND APPARATUS TO MANAGE PRIVACY IN VIDEO STREAMS

(71) Applicant: Intel Corporation, Santa Clara, CA (US)

(72) Inventors: Ilil Blum Shem-Tov, Kiryat Tivon (IL); Miriam Engel, Jerusalem (IL); Viki Almog-Ayzenberg, Haifa (IL); Dan Horovitz, Rishon Letzion (IL); Ilya Nelkenbaum, Tirat Karmel (IL)

(21) Appl. No.: 18/619,849

(22) Filed: Mar. 28, 2024

(51) Int. Cl. G06F 21/62; G06T 5/70; G06V 10/56; G06V 40/16

(52) U.S. Cl. CPC G06F 21/6254; G06T 5/70; G06V 10/56; G06V 40/168; G06V 40/178

(57) ABSTRACT

Systems, apparatus, articles of manufacture, and methods are disclosed. An example includes interface circuitry to access an image frame from a video stream during a presentation of the video stream, the image frame depicting a face; machine-readable instructions; and at least one processor circuit to be programmed by the machine-readable instructions to: determine that the face is associated with at least one of a person-specific privacy policy or a group privacy policy; obtain an obfuscation rule from the at least one of the person-specific privacy policy or the group privacy policy; determine an obfuscation state for the face in the video stream based on at least one of the obfuscation rule or a system operator policy; and cause the presentation of the video stream to depict the face based on the obfuscation state.

### FIELD OF THE DISCLOSURE

This disclosure relates generally to computer-based video processing and, more particularly, to methods and apparatus to manage privacy in video streams.

### BACKGROUND

Video cameras used to capture video are implemented in many types of devices including stationary camera devices and mobile devices. As such, video streams can be generated anywhere. Camera devices may be located in public areas, commercial venues, or private places. Such cameras may be used to stream video information of interest to the public such as beach conditions, shopping center congestion, etc.; for commercial purposes such as sporting events, concerts, etc.; or for private purposes such as security surveillance, private events, etc.

### BRIEF DESCRIPTION OF THE DRAWINGS

FIG. 1 is a block diagram of an example environment in which an example real-time region of interest (ROI) blur engine operates to manage privacy in video streams.

FIG. 2 is a block diagram of an example implementation of the real-time ROI blur engine of FIG. 1.

FIG. 3 is the example foundation model of the real-time ROI blur engine of FIG. 2 to generate a feature vector based on a depiction of a person in an image frame of a video stream.

FIG. 4 illustrates image frames of one or more video streams that depict obfuscated and non-obfuscated states of people.

FIG. 5 is a flowchart representative of example machine readable instructions and/or example operations that may be executed, instantiated, and/or performed by example programmable circuitry to implement the real-time ROI blur engine of FIG. 2.

FIG. 6 is a block diagram of an example processing platform including programmable circuitry structured to execute, instantiate, and/or perform the example machine readable instructions and/or perform the example operations of FIG. 5 to implement the real-time ROI blur engine of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale.

### DETAILED DESCRIPTION

Examples disclosed herein may be used to implement scalable real-time facial privacy protection systems for streamed events (e.g., mass-participants in streamed events, small-scale commercial video streaming, private-use video streaming, etc.). Video streaming technologies allow capturing video streams of people using multiple types of cameras. Also, video analysis systems allow analyzing behavior patterns of such people based on the captured video streams. There are several example use-cases where individuals are being photographed. Examples include mass events (e.g., music events, sporting events, etc.), live news broadcasts, online street cameras (which might also include voice), etc., private or public security surveillance, home monitoring, private events, etc. Some of the photographed population is subject to different privacy regulation laws such as workers, minors, security forces, police officers, paramedics, fire fighters, judges, lawyers, doctors, nurses, celebrities, etc.

Widespread video recording systems do not consider privacy consent and privacy rights of the population. In the vast majority of cases, such video recording systems do not request a person's consent for video recording and broadcasting.

Examples disclosed herein improve personal privacy management and protection for video systems. Examples disclosed herein may be scaled and customized to align with privacy regulations (e.g., General Data Protection Regulation (GDPR) of the European Union (EU), Digital Services Act (DSA) of the EU, California Consumer Privacy Act (CCPA) of the state of California in the United States of America, etc.). In examples disclosed herein, privacies of individuals are managed based on privacy policies such as one or more of person-specific privacy policies or group privacy policies (e.g., general privacy policies). For person-specific privacy policies, examples disclosed herein allow individual people to control their privacy exposure and how video or photography systems operate to apply relevant filters. According to some privacy regulations, companies may be required to collect consent for use of facial recognition technology. Such consent may be obtained from a user of a device during an enrollment process. The company may have internal policies about the use of facial recognition in the workplace. By allowing interactions between individuals and tracking and recording systems, examples disclosed herein can be used to manage privacies of individual people in a user-consent based manner that scales to many population sizes.

For circumstances in which interactions between individuals and tracking and recording systems is not available to set person-specific privacy policies (e.g., systems without user onboarding procedures, stadiums, mass events such as music concerts or sporting events, public monitoring systems such as street surveillance, etc.), examples disclosed herein may be used to apply group privacy policies to people depicted in video streams. In some examples, owners or operators of video tracking and recording systems may implement examples disclosed herein to select when to apply person-specific privacy policies, when to apply group privacy policies, and when to apply a combination of both.

Examples disclosed herein may be implemented to protect people on an individual-basis from being identified in real time in broadcast streaming events (e.g., sporting events, concerts, retail establishments, public area surveillance, demonstrations, online real-life cameras, private or public security surveillance, home monitoring, private events, etc.). Examples disclosed herein use facial recognition algorithms and models and other person recognition algorithms and models to analyze different people and apply privacy protections according to one or more predefined sets of rules.

Examples disclosed herein allow people to set their privacy settings in public spaces. Examples disclosed herein use such privacy settings to obfuscate (e.g., blur, block, etc.) specific individuals depicted in video streaming outputs, while depicting other people in those video streams without obfuscation. For example, techniques disclosed herein may be implemented by computer vision artificial intelligent (AI) algorithms that allow a streaming engine to apply person-specific privacy policies to cherry-pick individual people to obfuscate (e.g., selectively obfuscate different people) or a apply predefined group of policies to automatically obfuscate specific individuals (e.g., workers, minors, security forces, police officers, paramedics, fire fighters, lawyers, etc.) exclusive of others. In some implementations, documentation or instructions may be provided to an overall population reflecting capabilities for persons of that population to choose their privacy specifications, or to have one or more predefined policies automatically applied for video stream outputs.

Although examples disclosed herein are described in terms of real-time video streaming, examples disclosed herein may be similarly applied to streaming or broadcasting of still images.

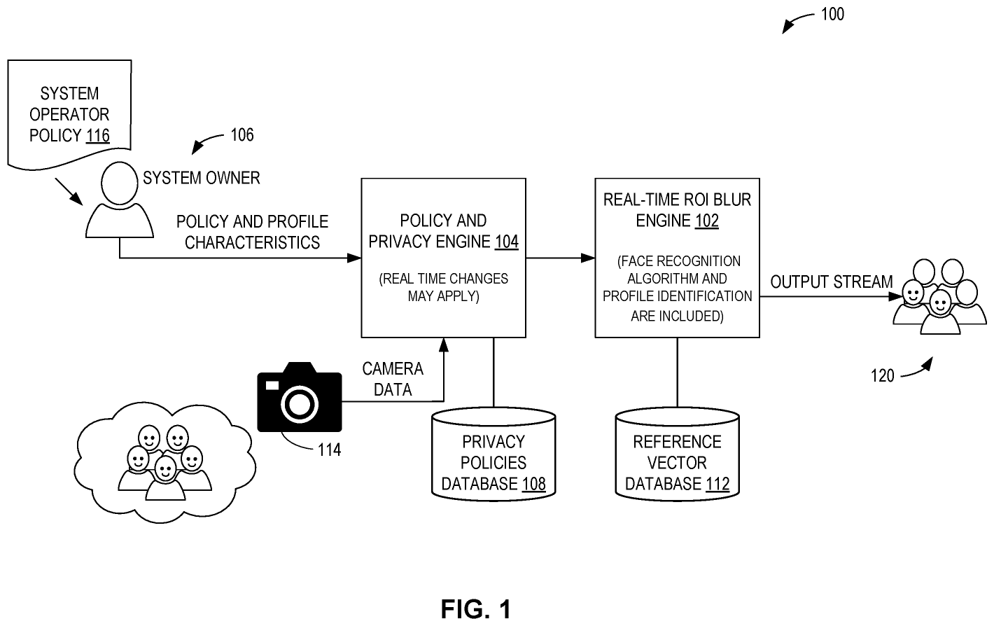

FIG. 1 is a block diagram of an example environment 100 in which an example real-time region of interest (ROI) blur engine 102 operates to manage personal privacies in video streams. The example environment also includes an example policy and privacy engine 104, an example system owner 106, an example privacy policies database 108, an example reference vector database 112, an example camera 114, and an example system operator policy 116. In example FIG. 1, the policy and privacy engine 104 is in communication with the real-time ROI blur engine 102, the policy and privacy engine 104 is in communication with the privacy policies database 108, and the real-time ROI blur engine 102 is in communication with the reference vector database 112. Also, the system owner 106 and the camera 114 communicate with the policy and privacy engine 104.

The real-time ROI blur engine 102 determines obfuscation states such as no obfuscation (e.g., depict a face without modification in an image frame) or obfuscation (e.g., blocking, redacting, face erasing, etc.) for faces recognized in image frames. Therefore, although the real-time ROI blur engine 102 is referred to as a blur engine, the real-time ROI blur engine 102 may obfuscate faces or people in image frames in any suitable manner in addition to or instead of blurring.

The policy and privacy engine 104 receives video streams from the camera 114. In some examples, such video streams are for real-time presentation (e.g., live broadcast). The privacy policies database 108 stores person-specific privacy policies and group privacy policies. The policy and privacy engine 104 accesses such policies from the privacy policies database 108. The privacy policies database 108 may be implemented using any suitable type of storage device (e.g., magnetic storage device(s), optical storage device(s), solid state memory device(s), etc.).

The policy and privacy engine 104 receives system operator policies 116 from a system owner 106 via a user interface of the policy and privacy engine 104. The system owner 106 at least one of owns or operates a video tracking and recording system in which the real-time ROI blur engine 102 and the policy and privacy engine 104 are implemented. The system operator policies 116 may define group privacy policies that the system owner 106 specifies to enforce on video streams captured by the camera 114 in an establishment or area monitored by video tracking and recording system of the system owner 106. The policy and privacy engine 104 stores the group privacy policies in the privacy policies database 108.

The system owner 106 can specify policy and profile characteristics in the system operator policies 116 to specify different privacy policies that apply to different people based on profile characteristics of those people. For example, the system owner 106 may use the system operator policy 116 to specify obfuscation of faces corresponding to uniforms (e.g., clothing) bearing the letters POLICE. In such examples, privacy protections are given to police officers in the establishment or area monitored by a video tracking and recording system of the system owner 106. In other examples, the system operator policy 116 may specify obfuscation of faces based on other types of characteristics such as types of clothing, clothing color, accessories, height, eye color, hair color, hair style, perceived age, or profession (e.g., security forces, police officers, paramedics, fire fighters, judges, lawyers, doctors, nurses, celebrities, etc.).

The real-time ROI blur engine 102 may include one or more computer vision AI algorithms to implement facial recognition algorithms and models or other person recognition algorithms and models to analyze different people and apply privacy protections according to one or more predefined sets of rules (e.g., privacy policies) identified by the policy and privacy engine 104. The real-time ROI blur engine 102 applies blurring or other types of obfuscation (e.g., blocking, redacting, face erasing, etc.) to faces in video streams captured by the camera 114. In some examples, the real-time ROI blur engine 102 is configured to apply such obfuscation in compliance with privacy laws or other data protection policies.

The real-time ROI blur engine 102 uses its computer vision AI algorithms to recognize individual people in image frames of a video stream and communicate identities of such people to the policy and privacy engine 104 to obtain person-specific privacy policies corresponding to those people.

The identities may be personal identifiers (e.g., the identity of an individual person) or group identifiers. A personal identifier identifies a particular individual person and may be government issued identifier (e.g., a driver's license number, a passport identifier, etc.), a venue identifier (e.g., assigned by an establishment hosting a mass event), an email address, a phone number, a username, or any other type of identifier to uniquely identify a person. A group identifier identifies a group (e.g., minors, security forces, police officers, paramedics, fire fighters, judges, lawyers, doctors, nurses, celebrities, etc.) to which a person belongs.

The real-time ROI blur engine 102 obtains the person-specific privacy policies and group privacy policies from the policy and privacy engine 104, and determines whether to apply one or both to determine obfuscation states of faces detected in the image frames. For example, the real-time ROI blur engine 102 applies facial recognition to detect people having person-specific privacy policies and distinguish such people from other people that do not have person-specific privacy policies. The real-time ROI blur engine 102 also detects characteristics of individuals that match group privacy policies. After marking individuals in an image frame, the real-time ROI blur engine 102 applies continuous face obfuscation to a video stream to generate a privacy-protection enhanced video stream 120. The real-time ROI blur engine 102 can provide the privacy-protection enhanced video stream 120 to a display controller to present the privacy-protection enhanced video stream 120 via a display. Additionally or alternatively, the real-time ROI blur engine 102 can provide the privacy-protection enhanced video stream 120 to a transmitter to broadcast the privacy-protection enhanced video stream 120 to receiving devices. The receiving devices can decode the privacy-protection enhanced video stream 120 for presentation on their display devices. In any case, the real-time ROI blur engine 102 causes presentation of the privacy-protection enhanced video stream 120 via one or more local or remote display devices.

If new individuals enter in an image frame (e.g., for more than 10 milliseconds or other suitable threshold duration), the real-time ROI blur engine 102 performs facial recognition or body characteristic recognition to recognize those individuals as corresponding to one or both of person-specific privacy policies or group privacy policies. The real-time ROI blur engine 102 applies an obfuscation algorithm to one or more of the individuals that are part of the current frame based on identified privacy policies. When a person is no longer detected in an image frame, the real-time ROI blur engine 102 stops its obfuscation process for that person because that obfuscation filter is not relevant anymore.

To detect persons that correspond to a group privacy policy, the real-time ROI blur engine 102 can apply AI algorithm models to analyze and detect them based on previous machine learning. In example FIG. 1, the AI algorithms include facial recognition algorithms and profile identification algorithms. However, examples disclosed herein are not limited to facial recognition algorithms. Instead, the real-time ROI blur engine 102 may additionally or alternatively include any other type of person recognition algorithm based on any combination of facial features, body characteristics, physical characteristics, clothing characteristics, etc.

Machine learning used to train the AI models can be based on facial features, body characteristics, or physical characteristics of a person to determine, for example, the age of a person, the height of a person, the gender of a person, etc. Machine learning may also be used to train AI models based on clothing of a person such as uniforms (e.g., security forces uniforms, police officer uniforms, paramedics uniforms, fire fighter uniforms, judge robes, doctor uniforms, nurse uniforms, etc.). In any case, the policy and privacy engine 104 triggers the real-time ROI blur engine 102 to apply a face recognition algorithm (or any other person recognition algorithm) to detect members of a group as specific individuals.

The real-time ROI blur engine 102 executes a profile identification algorithm to select one or more privacy person-specific policies or group privacy policies based on the recognition of individuals in an image frame. The real-time ROI blur engine 102 can apply privacy protections according to a predefined set of rules of a group privacy policy with or without the application of person-specific privacy policies. In this manner, the real-time ROI blur engine 102 defines the obfuscation regions of interest and the data to be exposed in the privacy-protection enhanced video stream 120 while obfuscating selected people according to one or more privacy policy(ies) corresponding to the profiles of those people.

The reference vector database 112 is provided to store reference feature vectors in association with at least one of personal identifiers or group identifiers. A reference feature vector is an array of values that represent image characteristics of a particular person or a group of people. For example, the array of values in a reference vector are derived from characteristics detectable in an image of a person. Such characteristics may be clothing, clothing color, accessories, height, eye color, eye positioning, hair color, hair style, body shape, eye shape, nose shape, mouth shape, etc. In some examples, the reference vector serves as a signature that uniquely identifies a person or uniquely identifies a type of person belonging to a particular group of people. The real-time ROI blur engine 102 may use the reference feature vectors from the reference vector database 112 to compare against feature vectors of people depicted in image frames to determine identities of those people and select corresponding privacy policies. The reference vector database 112 may be implemented using any suitable type of storage device (e.g., magnetic storage device(s), optical storage device(s), solid state memory device(s), etc.).

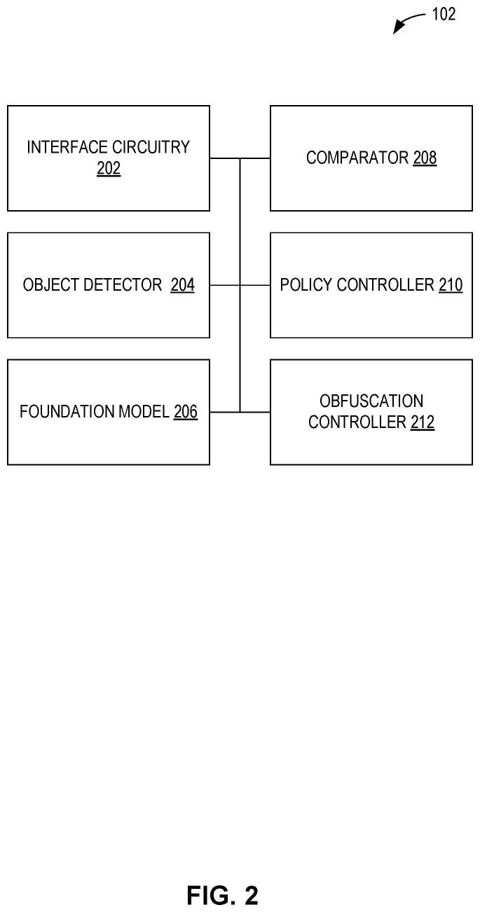

FIG. 2 is a block diagram of an example implementation of the real-time ROI blur engine 102 of FIG. 1 to manage personal privacies in video streams. The real-time ROI blur engine 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the real-time ROI blur engine 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The real-time ROI blur engine 102 includes example interface circuitry 202, example object detector circuitry 204, example foundation model circuitry 206, example comparator circuitry 208, example policy controller circuitry 210, and example obfuscation controller circuitry 212.

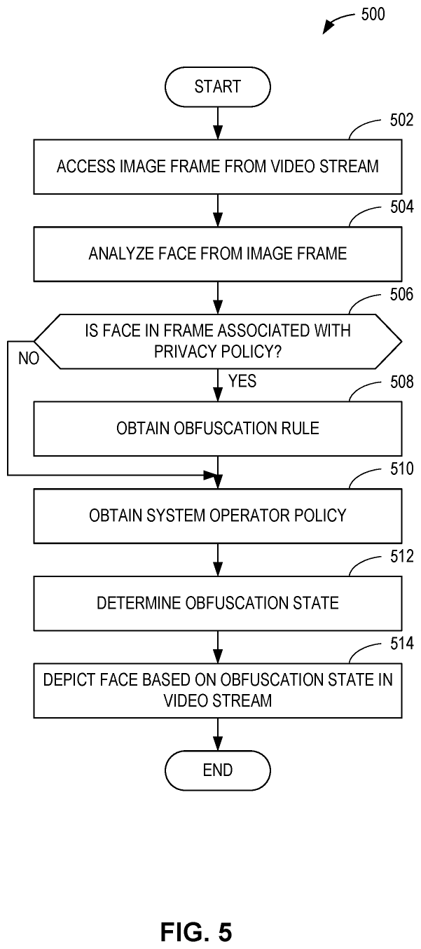

The interface circuitry 202 is provided to access an image frame from a video stream during a presentation of the video stream. The image frame depicts one or more faces. In some examples, the interface circuitry 202 is instantiated by programmable circuitry executing interface instructions and/or configured to perform operations such as those represented by the flowchart of FIG. 5.

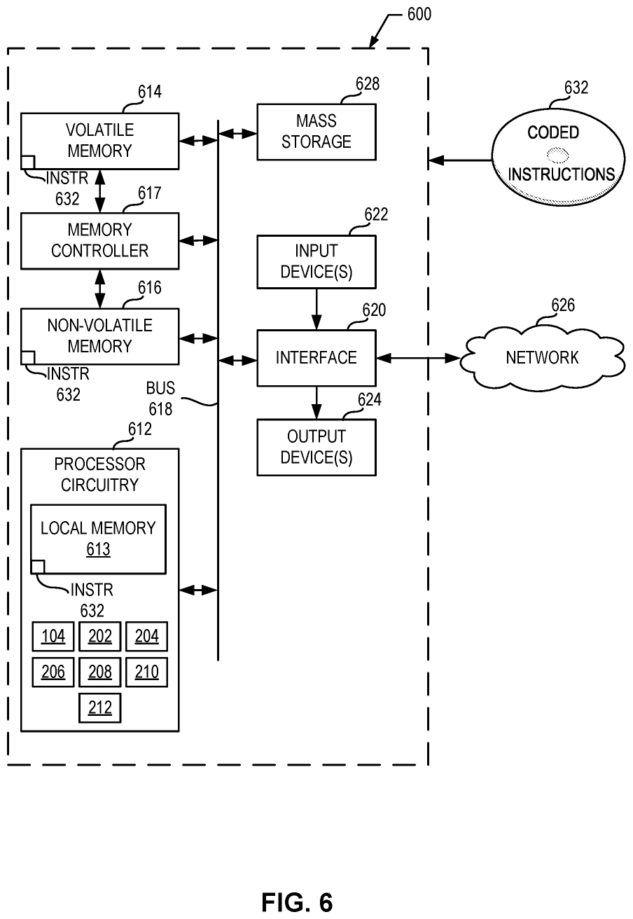

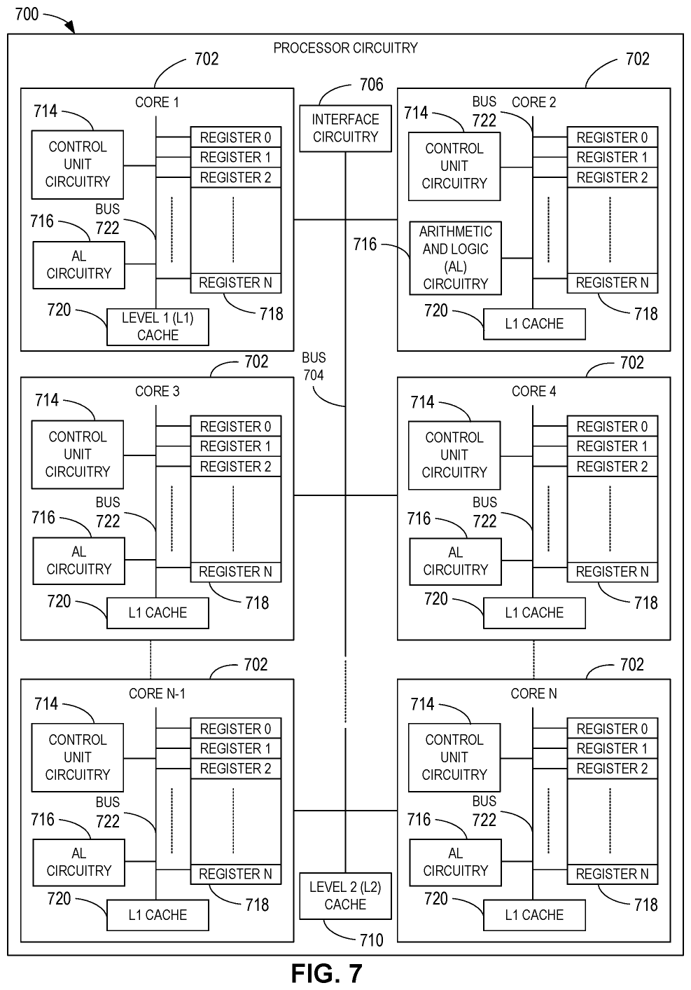

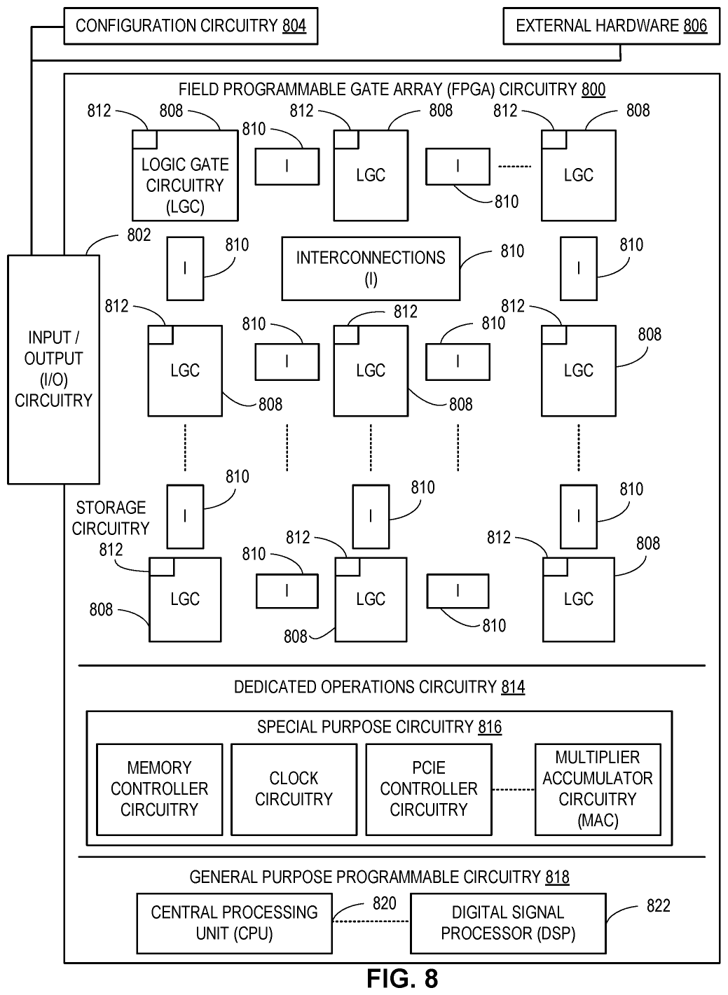

In some examples, the real-time ROI blur engine 102 includes means for accessing an image frame. For example, the means for accessing an image frame may be implemented by the interface circuitry 202. In some examples, the interface circuitry 202 may be instantiated by programmable circuitry such as the example programmable circuitry 612 of FIG. 6. For instance, the interface circuitry 202 may be instantiated by the example microprocessor 700 of FIG. 7 executing machine executable instructions such as those implemented by at least block 502 of FIG. 5. In some examples, the interface circuitry 202 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the interface circuitry 202 may be instantiated by any other combination of hardware, software, and/or firmware. For example, the interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example object detector circuitry 204 is provided to detect at least one of persons or faces in image frames of video streams. For example, the object detector circuitry 204 may detect the presence of persons or faces based on body characteristics or facial characteristics. In some examples, the object detector circuitry 204 is instantiated by programmable circuitry executing object detector instructions and/or configured to perform operations such as those represented by the flowchart of FIG. 5.

In some examples, the real-time ROI blur engine 102 includes means for detecting at least one of persons or faces in image frames. For example, the means for detecting at least one of persons or faces may be implemented by the object detector circuitry 204. In some examples, the object detector circuitry 204 may be instantiated by programmable circuitry such as the example programmable circuitry 612 of FIG. 6. For instance, the object detector circuitry 204 may be instantiated by the example microprocessor 700 of FIG. 7 executing machine executable instructions to detect persons or faces in image frames. In some examples, the object detector circuitry 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the object detector circuitry 204 may be instantiated by any other combination of hardware, software, and/or firmware. For example, the object detector circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

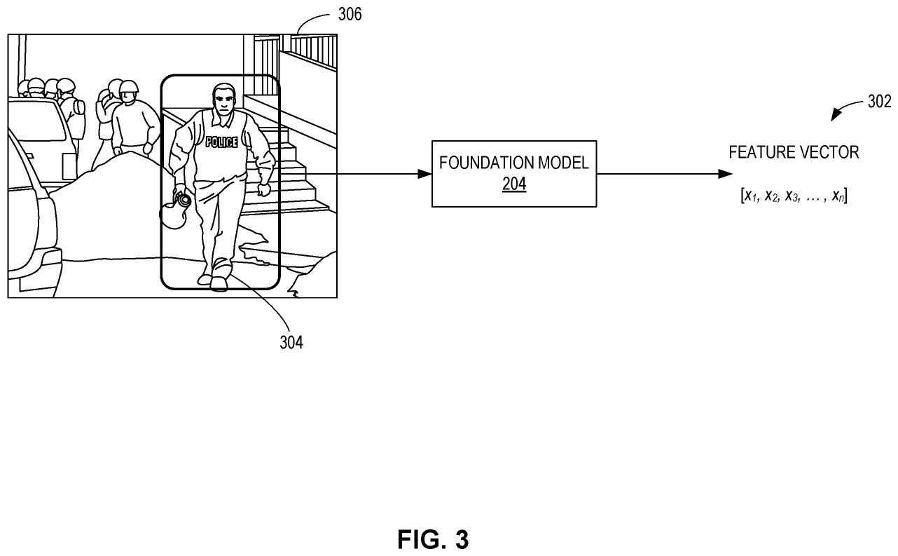

The foundation model circuitry 206 is provided to recognize people in image frames based on one or more of facial features, body characteristics, physical characteristics, clothing characteristics, etc. For example, based on image representations of people detected by the object detector circuitry 204 in image frames, the foundation model circuitry 206 generates feature vectors of those people based on their depictions (e.g., facial depictions, body depictions, physical depictions, clothing depictions, etc.). Through identification of people using the foundation model circuitry 206, the real-time ROI blur engine 102 can determine that a face in an image frame is associated with at least one of a person-specific privacy policy or a group privacy policy. The foundation model circuitry 206 is described in detail below in connection with FIG. 3. In some examples, the foundation model circuitry 206 is instantiated by programmable circuitry executing foundation model instructions and/or configured to perform operations such as those represented by the flowchart of FIG. 5.

In some examples, the real-time ROI blur engine 102 includes means recognizing people in image frames. For example, the means for recognizing people in image frames may be implemented by the foundation model circuitry 206. In some examples, the foundation model circuitry 206 may be instantiated by programmable circuitry such as the example programmable circuitry 612 of FIG. 6. For instance, the foundation model circuitry 206 may be instantiated by the example microprocessor 700 of FIG. 7 executing machine executable instructions such as those implemented by at least block 504 of FIG. 5. In some examples, the foundation model circuitry 206 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the foundation model circuitry 206 may be instantiated by any other combination of hardware, software, and/or firmware. For example, the foundation model circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The comparator circuitry 208 is provided to compare feature vectors generated by the foundation model circuitry 206 with reference feature vectors stored in the reference vector database 112 of FIG. 1. In some examples, the comparator circuitry 208 is instantiated by programmable circuitry executing comparator instructions and/or configured to perform operations such as those represented by the flowchart of FIG. 5.

In some examples, the real-time ROI blur engine 102 includes means comparing feature vectors. For example, the means for comparing feature vectors may be implemented by the comparator circuitry 208. In some examples, the comparator circuitry 208 may be instantiated by programmable circuitry such as the example programmable circuitry 612 of FIG. 6. For instance, the comparator circuitry 208 may be instantiated by the example microprocessor 700 of FIG. 7 executing machine executable instructions such as those implemented by at least block 504 of FIG. 5. In some examples, the comparator circuitry 208 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the comparator circuitry 208 may be instantiated by any other combination of hardware, software, and/or firmware. For example, the comparator circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The policy controller circuitry 210 is provided to determine that a face depicted in an image frame is associated with at least one of a person-specific privacy policy or a group privacy policy. In some examples, the policy controller circuitry 210 is instantiated by programmable circuitry executing policy controller instructions and/or configured to perform operations such as those represented by the flowchart of FIG. 5.

In some examples, the real-time ROI blur engine 102 includes means for determining whether the face is associated with at least one of a person-specific privacy policy or a group privacy policy. For example, the means for determining whether the face is associated with at least one of a person-specific privacy policy or a group privacy policy may be implemented by the policy controller circuitry 210. In some examples, the policy controller circuitry 210 may be instantiated by programmable circuitry such as the example programmable circuitry 612 of FIG. 6. For instance, the policy controller circuitry 210 may be instantiated by the example microprocessor 700 of FIG. 7 executing machine executable instructions such as those implemented by at least block 506 of FIG. 5. In some examples, the policy controller circuitry 210 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the policy controller circuitry 210 may be instantiated by any other combination of hardware, software, and/or firmware. For example, the policy controller circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The obfuscation controller circuitry 212 is provided to obtain an obfuscation rule from at least one of a person-specific privacy policy or a group privacy policy stored in the privacy policies database 108. The obfuscation controller circuitry 212 is also provided to determine an obfuscation state for a face in a video stream based on at least one of the obfuscation rule or a system operator policy. The obfuscation controller circuitry 212 also causes presentation of a video stream to depict the face based on the obfuscation state. For example, the obfuscation controller circuitry 212 may modify image frames of a video stream to obfuscate faces of people according to the privacy policies identified by the policy controller circuitry 210. The obfuscation controller circuitry 212 provides the modified image frames in the corresponding video stream to cause a display controller to display the obfuscated version of the video stream. In some examples, the obfuscation controller circuitry 212 is instantiated by programmable circuitry executing obfuscation controller instructions and/or configured to perform operations such as those represented by the flowchart of FIG. 5.

In some examples, the real-time ROI blur engine 102 includes means for obtaining an obfuscation rule. For example, the means for obtaining an obfuscation rule may be implemented by the obfuscation controller circuitry 212. In some examples, the obfuscation controller circuitry 212 may be instantiated by programmable circuitry such as the example programmable circuitry 612 of FIG. 6. For instance, the obfuscation controller circuitry 212 may be instantiated by the example microprocessor 700 of FIG. 7 executing machine executable instructions such as those implemented by at least block 508 of FIG. 5. In some examples, the obfuscation controller circuitry 212 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the obfuscation controller circuitry 212 may be instantiated by any other combination of hardware, software, and/or firmware. For example, the obfuscation controller circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for determining includes means for obtaining an obfuscation rule also determines an obfuscation state for a face in a video stream. In some examples, the means for determining includes means for obtaining an obfuscation rule also causes presentation of the video stream to depict the face based on the obfuscation state.

In some examples, the comparator circuitry 208 determines that a first face in an image frame of a video stream is associated with at least one of a person-specific privacy policy or a group privacy policy and that a second face in the image frame is not associated with person-specific privacy. In such examples, the obfuscation controller circuitry 212 causes a presentation of the video stream to apply an obfuscation state (e.g., with or without obfuscation) to the second face based on the system operator policy 116. For example, the system owner 106 may specify in the system operator policy 116 that faces of all people associated with a particular group are to be obfuscated in an image frame regardless of whether they have person-specific privacy policies, while other people in that image frame can be depicted, with or without obfuscation, according to person-specific privacy policies, other group privacy policies not controlled by the system owner 106, or lack of privacy policies.

FIG. 3 is the example foundation model circuitry 206 of FIG. 2 to generate a feature vector 302 based on a depiction of a person 304 in an image frame 306 of a video stream. Unlike traditional computer vision AI systems that have poor scalability due to training of the systems requiring numerous practice sets to adopt new policies (e.g., minors, people with uniforms, etc.), the foundation model circuitry 206 overcomes such scalability issues. To support new profiles of specific people at scale, the real-time ROI blur engine 102 uses the foundation model circuitry 206 to adopt new policies quickly and efficiently.

The foundation model circuitry 206 may be implemented by a universal convolutional neural network model that is trained on huge, rich, and diverse datasets. The data used for training the foundation model circuitry 206 is taken from multiple sources and contains billions of images. As such, the training data can represent any image content representable in captured video streams (e.g., in natural images captured by a camera). The training data can also represent profile characteristics of different people to configure the foundation model circuitry 206 as a person-detection solution that overcomes scalability issues that arise when the real-time ROI blur engine 102 is expected to process billions of unique faces and associated policies for video tracking and recording systems. Examples of different types of models that may be used to implement the foundation model circuitry 206 include Contrastive Language-Image Pre-training (CLIP) models, Contrastive Captioners (COCA) models, and DINOv2 models. Any other suitable type of model may also be used.

The foundation model circuitry 206 does not require additional training when a new profiling policy is added. The foundation model circuitry 206 serves as a universal feature extractor for each person/face detected by the object detector circuitry 204 in the real-time ROI blur engine 102. The foundation model circuitry 206 translates an object of interest to a long vector of numbers (e.g., a 512-number vector, a 1024-number vector, a 2048-number vector, etc.) as is represented by the feature vector 302 (e.g., [x₁, x₂, x₃, . . . , xₙ]).

Each new policy added to the privacy policies database 108 during a registration phase is accompanied by a multiple examples defining a person profile that is to be differentiated by the foundation model circuitry 206. During the registration phase, the foundation model circuitry 206 extracts a feature vector 302 for each example of multiple examples associated with the person profile. In examples disclosed herein, multiple examples of a person profile may correspond to different perspectives, different lighting conditions, different color shading, different clothing, different color uniform apparel, different accessories, etc. that could affect how a person appears in an image frame. During the registration phase, the foundation model circuitry 206 uses the multiple feature vectors generated for the person profile to form a cluster of feature vectors in an N-dimensional space. Such cluster of feature vectors characterizes a specific policy for an individual person or a group of people. In such examples, clusters of feature vectors improve the robustness of recognition processes performed by the foundation model circuitry 206 because recognition is based on multiple feature vectors for a person rather than just one. In some examples, the cluster of feature vectors does not require personal identification, thereby further protecting user privacies.

During a test phase or recognition phase, the foundation model circuitry 206 checks each person of interest in an image frame to determine whether that person belongs to a registered privacy policy in the privacy policy database 108. For example, the foundation model circuitry 206 generates a current feature vector for a person under test in the image frame, compares the current feature vector of that person to a cluster of reference feature vectors in the reference vector database 112 for all registered privacy policies, and determines (e.g., measures) the distances between the feature vector 302 and the reference feature vectors. Based on those distances, the policy controller circuitry 210 determines whether the person under test belongs to a predefined profile policy corresponding to a registered privacy policy in the privacy profile database 108. For example, the policy controller circuitry 210 may determine that the person under test is associated with a particular privacy policy when the distance between the current feature vector of that person and a reference feature vector satisfies a threshold (e.g., is less than a threshold). A value for the threshold may be selected based on a desired accuracy of the person-recognition process. When the policy controller circuitry 210 determines that the person under test is associated with a particular privacy policy registered in the privacy policy database 108, the policy controller circuitry 210 selects the corresponding privacy policy from the privacy policies database 108. The obfuscation controller circuitry 212 selects one or more obfuscation rules from the privacy policy to implement a proper security measure (e.g., obfuscating or not obfuscating the face of the person under test).

In some examples, the foundation model circuitry 206 is implemented by training it as a lightweight model (e.g., via distillation). Once trained in this manner, the lightweight model implements the functionality of a foundation model for use in live streaming. The foundation model circuitry 206 can perform distance calculations between feature vectors of new person/face objects and clusters of reference feature vectors for multiple registered privacy policies in real time, even for many policies and test objects.

In some implementations, the foundation model circuitry 206 may not be able to perform face recognition for faces represented in low resolution (e.g., a resolution lower than a resolution threshold such as an 8×8 pixel representation of a face). In such examples, the object detector circuitry 204 can detect faces in image frames of a real-time video stream based on existing face detection algorithms. However, after determining the resolution of a face is less than a resolution useable by the foundation model circuitry 206, the obfuscation controller circuitry 212 performs a pre-processing of the image frame to obfuscate faces with lower resolution by default. Faces represented with higher resolution (e.g., greater than a resolution threshold) are processed by the foundation model circuitry 206, as described above.

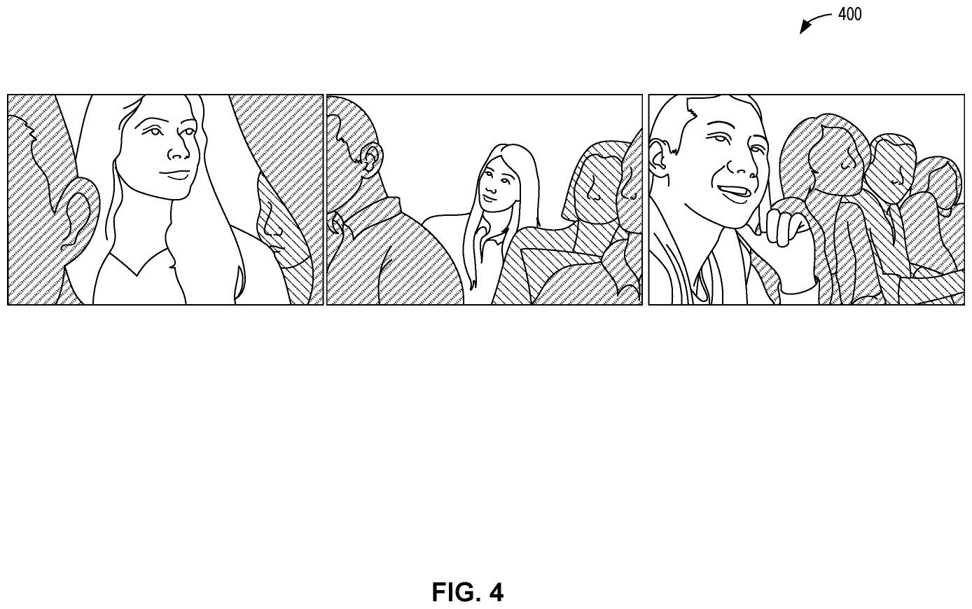

FIG. 4 illustrates example image frames 400 of one or more video streams that depict obfuscated and non-obfuscated states of people. In such examples, the real-time ROI blur engine 102 implements a featured called “Blur all beside me/us,” also referred to herein as an “all-but-me obfuscation filter.” To implement the all-but-me obfuscation filter, the real-time ROI blur engine 102 uses privacy settings of one or more of owned systems (e.g., a video tracking and recording system of the system owner 106), public spaces, or person-specific preferences to pre-process a captured video stream so that only a particular user and any partners (e.g., members of the same party, family, etc.) are depicted without modification in the video stream while concurrently obfuscating other faces in the video stream. For example, the real-time ROI blur engine 102 processes pictures or videos of family\friends in public places to apply obfuscation based on a pre-defined user set of people specified in a privacy policy for the all-but-me obfuscation filter. In other examples, the real-time ROI blur engine 102 can process real-time broadcasts from educational institutions to selectively apply the all-but-me obfuscation filter on a parent-to-child basis. For example, the obfuscation controller circuitry 212 obfuscates depictions of all children in a video stream but one or more children belonging to a parent receiving that video stream. In this manner, the obfuscation controller circuitry 212 provides a privacy-protection enhanced video stream 120 to a parent that reveals faces of only the child or children belonging to that parent. In some examples, the privacy-protection enhanced video stream 120 can also reveal faces of staff (e.g., teachers, administration, etc.) depending on the privacy policies of the staff. In any case, the obfuscation controller circuitry 212 can apply the all-but-me obfuscation filter to obfuscate people in a background or people associated with specific privacy policies while allowing other individuals to be depicted without modification in a video stream.

While an example manner of implementing the real-time ROI blur engine 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the policy and privacy engine 104, the interface circuitry 202, the object detector circuitry 204, the foundation model circuitry 206, the comparator circuitry 208, the policy controller circuitry 210, the obfuscation controller circuitry 212, and/or, more generally, the example real-time ROI blur engine 102 of FIG. 2, may be implemented by hardware alone or by hardware in combination with software and/or firmware. Thus, for example, any of the policy and privacy engine 104, the interface circuitry 202, the object detector circuitry 204, the foundation model circuitry 206, the comparator circuitry 208, the policy controller circuitry 210, the obfuscation controller circuitry 212, and/or, more generally, the example real-time ROI blur engine 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example real-time ROI blur engine 102 of FIG. 2 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed by programmable circuitry to implement and/or instantiate the real-time ROI blur engine 102 of FIG. 2 and/or representative of example operations which may be performed by programmable circuitry to implement and/or instantiate the real-time ROI blur engine 102 of FIG. 2, are shown in FIG. 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example real-time ROI blur engine 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to manage personal privacies in video streams. The example machine-readable instructions and/or the example operations 500 of FIG. 5 begin at block 502, at which the interface circuitry 202 accesses an image frame from a video stream during a presentation of the video stream. The image frame depicts at least one face.

The foundation model circuitry 206 analyzes the face from the image frame (block 504). The policy controller circuitry 210 determines whether the face in the image frame is associated with at least one of a person-specific privacy policy or a group privacy policy in the privacy policies database 108 (block 506).

If the policy controller circuitry 210 determines that the face in the image frame is not associated with at least one of a person-specific privacy policy or a group privacy policy (block 506: NO), control advances to block 510. If the policy controller circuitry 210 determines that the face in the image frame is associated with at least one of a person-specific privacy policy or a group privacy policy (block 506: YES), the obfuscation controller circuitry 212 obtains an obfuscation rule from the at least one of the person-specific privacy policy or the group privacy policy in the privacy policies database 108 (block 508).

The policy controller circuitry 210 obtains the system operator policy 116 (block 510). For example, the policy controller circuitry 210 may obtain the system operator policy 116 from the privacy policies database 108. The obfuscation controller circuitry 212 determines an obfuscation state for the face in the video stream based on at least one of the obfuscation rule or the system operator policy 116 (block 512). For example, if the system operator policy 116 specifies that it does not override a person-specific privacy policy or a group privacy policy, the obfuscation controller circuitry 212 determines the obfuscation state (e.g., to obfuscate a face or not to obfuscate a face) based on the person-specific privacy policy or the group privacy policy identified at block 506. Otherwise, if the system operator policy 116 specifies that it does override a person-specific privacy policy or a group privacy policy, the obfuscation controller circuitry 212 determines the obfuscation state (e.g., to obfuscate a face or not to obfuscate a face) based on the system operator policy 116 (e.g., a general privacy policy).

The obfuscation controller circuitry 212 causes the presentation of the video stream to depict the face based on the obfuscation state (block 514). The instructions or operations 500 of FIG. 5 end. One or more of the instructions or operations 500 may be performed multiple times to process multiple faces detected by the object detector circuitry 204 in one or more image frames of a video stream.

FIG. 6 is a block diagram of an example programmable circuitry platform 600 structured to execute and/or instantiate the example machine-readable instructions and/or the example operations of FIG. 5 to implement the real-time ROI blur engine 102 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the policy and privacy engine 104, the interface circuitry 202, the object detector circuitry 204, the foundation model circuitry 206, the comparator circuitry 208, the policy controller circuitry 210, and the obfuscation controller circuitry 212.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIG. 5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIG. 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIG. 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 5. As such, the FPGA circuitry 800 may be configured and/or structured to effectively instantiate some or all of the operations/functions corresponding to the machine readable instructions of the flowchart(s) of FIG. 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIG. 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIG. 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIG. 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 5, and/or an ASIC may be configured and/or structured to perform third operation(s)/function(s) corresponding to a third portion of the machine readable instructions represented by the flowcharts of FIG. 5.

It should be understood that some or all of the circuitry of FIG. 2 may thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of

FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

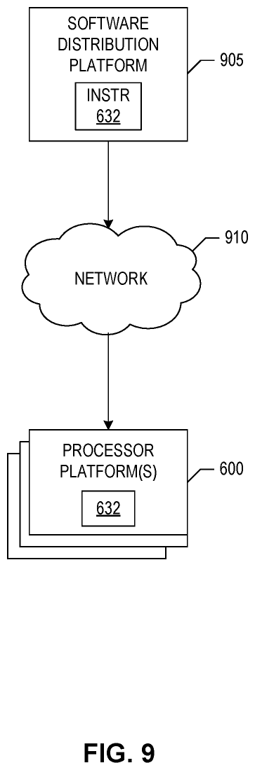

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIG. 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 5, may be downloaded to the example programmable circuitry platform 600, which is to execute the machine readable instructions 632 to implement the real-time ROI blur engine 102. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “real time” and “real-time” refer to occurrence in a near instantaneous manner recognizing there may be real-world delays for computing time, transmission, etc. Thus, unless otherwise specified, “real time” and “real-time” refer to being within one second of an occurrence of an event.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that manage privacy in video streams. Disclosed systems, apparatus, articles of manufacture, and methods improve the efficiency of using a computing device by using facial recognition algorithms and models and other person recognition algorithms and models to analyze different people depicted in video streams and apply privacy protections according to one or more privacy policies. For example, disclosed techniques apply one or more of person-specific privacy policies or group privacy policies to obfuscate persons depicted in video streams in real time during video stream presentations. By using machine learning and foundation models, examples disclosed herein may be scaled for use with many population sizes. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage privacy in video streams are disclosed herein. Further examples and combinations thereof include the following:

Example 1 includes an apparatus that includes interface circuitry to access an image frame from a video stream during a presentation of the video stream, the image frame depicting a face, machine-readable instructions, and at least one processor circuit to be programmed by the machine-readable instructions to determine that the face is associated with at least one of a person-specific privacy policy or a group privacy policy, obtain an obfuscation rule from the at least one of the person-specific privacy policy or the group privacy policy, determine an obfuscation state for the face in the video stream based on at least one of the obfuscation rule or a system operator policy, and cause the presentation of the video stream to depict the face based on the obfuscation state.

Example 2 includes the apparatus of example 1, wherein to cause the video stream to depict the face based on the obfuscation state, one or more of the at least one processor circuit is to apply an obfuscation filter to the face in the video stream to cause the video stream to depict an obfuscated state of the face.

Example 3 includes the apparatus of example 2, wherein the obfuscated state of the face is a blurred representation of the face.

Example 4 includes the apparatus of example 1, wherein one or more of the at least one processor circuit is to use a foundation model to determine that the face is associated with the at least one of the person-specific privacy policy or the group privacy policy.

Example 5 includes the apparatus of example 1, wherein one or more of the at least one processor circuit is to generate a feature vector for a person, the person corresponding to the face depicted in the image frame, and determine that the feature vector is associated with the at least one of the person-specific privacy policy or the group privacy policy based on a distance between the feature vector and a reference feature vector satisfying a threshold.

Example 6 includes the apparatus of example 1, wherein one or more of the at least one processor circuit is to determine that the face is associated with the at least one of the person-specific privacy policy or the group privacy policy based on at least one of clothing, clothing color, accessories, height, eye color, hair color, hair style, age, or profession of a person corresponding to the face.

Example 7 includes the apparatus of example 1, wherein one or more of the at least one processor circuit is to determine that a second face in the image frame is not associated with person-specific privacy, and cause the presentation of the video stream to apply the obfuscation state to the second face based on the system operator policy.

Example 8 includes at least one non-transitory machine-readable medium that includes machine-readable instructions to cause at least one processor circuit to at least access an image frame from a video stream during a presentation of the video stream, the image frame depicting a face, obtain an obfuscation rule from the at least one of a person-specific privacy policy or a group privacy policy corresponding to the face, determine an obfuscation state for the face in the video stream based on at least one of the obfuscation rule or a system operator policy, and cause the presentation of the video stream to depict the face based on the obfuscation state.

Example 9 includes the at least one non-transitory machine-readable medium of example 8, wherein to cause the video stream to depict the face based on the obfuscation state, the machine-readable instructions are to cause one or more of the at least one processor circuit to apply an obfuscation filter to the face in the video stream to cause the video stream to depict an obfuscated state of the face.

Example 10 includes the at least one non-transitory machine-readable medium of example 9, wherein the obfuscated state of the face is a blurred representation of the face.

Example 11 includes the at least one non-transitory machine-readable medium of example 8, wherein the machine-readable instructions are to cause one or more of the at least one processor circuit to execute a foundation model to determine that the face is associated with the at least one of the person-specific privacy policy or the group privacy policy.

Example 12 includes the at least one non-transitory machine-readable medium of example 8, wherein the machine-readable instructions are to cause one or more of the at least one processor circuit to generate a feature vector for a person, the person corresponding to the face depicted in the image frame, and determine that the feature vector is associated with the at least one of the person-specific privacy policy or the group privacy policy based on a distance between the feature vector and a reference feature vector satisfying a threshold.

Example 13 includes the at least one non-transitory machine-readable medium of example 8, wherein the machine-readable instructions are to cause one or more of the at least one processor circuit to determine that the face is associated with the at least one of the person-specific privacy policy or the group privacy policy based on at least one of clothing, clothing color, accessories, height, eye color, hair color, hair style, age, or profession of a person corresponding to the face.

Example 14 includes the at least one non-transitory machine-readable medium of example 8, wherein the machine-readable instructions are to cause one or more of the at least one processor circuit to determine that a second face in the image frame is not associated with person-specific privacy, and cause the presentation of the video stream to apply the obfuscation state to the second face based on the system operator policy.

Example 15 includes a method that includes accessing an image frame from a video stream during a presentation of the video stream, the image frame depicting a face, obtaining, by at least one processor circuit programmed by at least one instruction, an obfuscation rule from the at least one of a person-specific privacy policy or a group privacy policy corresponding to the face, determining, by one or more of the at least one processor circuit, an obfuscation state for the face in the video stream based on at least one of the obfuscation rule or a system operator policy, and depicting the face based on the obfuscation state during the presentation of the video stream.

Example 16 includes the method of example 15, wherein the depicting of the face based on the obfuscation state includes applying an obfuscation filter to the face in the video stream.

Example 17 includes the method of example 15, including executing a foundation model to determine that the face is associated with the at least one of the person-specific privacy policy or the group privacy policy.

Example 18 includes the method of example 15, including generating a feature vector for a person, the person corresponding to the face depicted in the image frame, and determining that the feature vector is associated with the at least one of the person-specific privacy policy or the group privacy policy based on a distance between the feature vector and a reference feature vector satisfying a threshold.

Example 19 includes the method of example 15, including determining that the face is associated with the at least one of the person-specific privacy policy or the group privacy policy based on at least one of clothing, clothing color, accessories, height, eye color, hair color, hair style, age, or profession of a person corresponding to the face.

Example 20 includes the method of example 15, including determining that a second face in the image frame is not associated with person-specific privacy, and applying the obfuscation state to the second face during the presentation of the video stream based on the system operator policy.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to access an image frame from a video stream during a presentation of the video stream, the image frame depicting a face;
machine-readable instructions; and
at least one processor circuit to be programmed by the machine-readable instructions to:
determine that the face is associated with at least one of a person-specific privacy policy or a group privacy policy;
obtain an obfuscation rule from the at least one of the person-specific privacy policy or the group privacy policy;
determine an obfuscation state for the face in the video stream based on at least one of the obfuscation rule or a system operator policy; and
cause the presentation of the video stream to depict the face based on the obfuscation state.

2. The apparatus of claim 1, wherein to cause the video stream to depict the face based on the obfuscation state, one or more of the at least one processor circuit is to apply an obfuscation filter to the face in the video stream to cause the video stream to depict an obfuscated state of the face.

3. The apparatus of claim 2, wherein the obfuscated state of the face is a blurred representation of the face.

4. The apparatus of claim 1, wherein one or more of the at least one processor circuit is to use a foundation model to determine that the face is associated with the at least one of the person-specific privacy policy or the group privacy policy.

5. The apparatus of claim 1, wherein one or more of the at least one processor circuit is to:
generate a feature vector for a person, the person corresponding to the face depicted in the image frame; and
determine that the feature vector is associated with the at least one of the person-specific privacy policy or the group privacy policy based on a distance between the feature vector and a reference feature vector satisfying a threshold.

6. The apparatus of claim 1, wherein one or more of the at least one processor circuit is to determine that the face is associated with the at least one of the person-specific privacy policy or the group privacy policy based on at least one of clothing, clothing color, accessories, height, eye color, hair color, hair style, age, or profession of a person corresponding to the face.

7. The apparatus of claim 1, wherein one or more of the at least one processor circuit is to:
determine that a second face in the image frame is not associated with person-specific privacy; and
cause the presentation of the video stream to apply the obfuscation state to the second face based on the system operator policy.

8. At least one non-transitory machine-readable medium comprising machine-readable instructions to cause at least one processor circuit to at least:
access an image frame from a video stream during a presentation of the video stream, the image frame depicting a face;
obtain an obfuscation rule from the at least one of a person-specific privacy policy or a group privacy policy corresponding to the face;
determine an obfuscation state for the face in the video stream based on at least one of the obfuscation rule or a system operator policy; and
cause the presentation of the video stream to depict the face based on the obfuscation state.

9. The at least one non-transitory machine-readable medium of claim 8, wherein to cause the video stream to depict the face based on the obfuscation state, the machine-readable instructions are to cause one or more of the at least one processor circuit to apply an obfuscation filter to the face in the video stream to cause the video stream to depict an obfuscated state of the face.

10. The at least one non-transitory machine-readable medium of claim 9, wherein the obfuscated state of the face is a blurred representation of the face.

11. The at least one non-transitory machine-readable medium of claim 8, wherein the machine-readable instructions are to cause one or more of the at least one processor circuit to execute a foundation model to determine that the face is associated with the at least one of the person-specific privacy policy or the group privacy policy.

12. The at least one non-transitory machine-readable medium of claim 8, wherein the machine-readable instructions are to cause one or more of the at least one processor circuit to:
generate a feature vector for a person, the person corresponding to the face depicted in the image frame; and
determine that the feature vector is associated with the at least one of the person-specific privacy policy or the group privacy policy based on a distance between the feature vector and a reference feature vector satisfying a threshold.

13. The at least one non-transitory machine-readable medium of claim 8, wherein the machine-readable instructions are to cause one or more of the at least one processor circuit to determine that the face is associated with the at least one of the person-specific privacy policy or the group privacy policy based on at least one of clothing, clothing color, accessories, height, eye color, hair color, hair style, age, or profession of a person corresponding to the face.

14. The at least one non-transitory machine-readable medium of claim 8, wherein the machine-readable instructions are to cause one or more of the at least one processor circuit to:
determine that a second face in the image frame is not associated with person-specific privacy; and
cause the presentation of the video stream to apply the obfuscation state to the second face based on the system operator policy.

15. A method comprising:
accessing an image frame from a video stream during a presentation of the video stream, the image frame depicting a face;
obtaining, by at least one processor circuit programmed by at least one instruction, an obfuscation rule from the at least one of a person-specific privacy policy or a group privacy policy corresponding to the face;
determining, by one or more of the at least one processor circuit, an obfuscation state for the face in the video stream based on at least one of the obfuscation rule or a system operator policy; and
depicting the face based on the obfuscation state during the presentation of the video stream.

16. The method of claim 15, wherein the depicting of the face based on the obfuscation state includes applying an obfuscation filter to the face in the video stream.

17. The method of claim 15, including executing a foundation model to determine that the face is associated with the at least one of the person-specific privacy policy or the group privacy policy.

18. The method of claim 15, including:
generating a feature vector for a person, the person corresponding to the face depicted in the image frame; and
determining that the feature vector is associated with the at least one of the person-specific privacy policy or the group privacy policy based on a distance between the feature vector and a reference feature vector satisfying a threshold.

19. The method of claim 15, including determining that the face is associated with the at least one of the person-specific privacy policy or the group privacy policy based on at least one of clothing, clothing color, accessories, height, eye color, hair color, hair style, age, or profession of a person corresponding to the face.

20. The method of claim 15, including:
determining that a second face in the image frame is not associated with person-specific privacy; and
applying the obfuscation state to the second face during the presentation of the video stream based on the system operator policy.
